(19) United States
(12) Patent Application Publication
(10) Pub. No.: US 2008/0126905 A1
(43) Pub. Date: May 29, 2008

(54) MEMORY CONTROL DEVICE, COMPUTER SYSTEM AND DATA REPRODUCING AND RECORDING DEVICE

(75) Inventors: Naoto DEGUCHI, Osaka (JP); Keizo SUMIDA, Osaka (JP); Yasunori YAMAMOTO, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/946,148

(22) Filed: Nov. 28, 2007

(30) Foreign Application Priority Data
Nov. 29, 2006 (JP) 2006-322471

(51) Int. Cl. G06F 11/00

(52) U.S. Cl. 714/746; 714/E11.001

(57) ABSTRACT

The memory control device according to the present invention reads data including an error correcting code from a memory and includes: an error correcting unit which detects an error in the data and corrects the detected error in the data, based on the error correcting code, and sends the error detected and error corrected data to the outside; and a selector which selects whether to send the data read from the memory to the error correcting unit or to the outside.

### BACKGROUND OF THE INVENTION

(1) Field of the Invention

The present invention relates to a memory control device, a computer system, and a data reproducing and recording device, and particularly to a memory control device which reads data and error correcting codes from a memory.

(2) Description of the Related Art

Electronic noise, defective memory cells, incoming cosmic rays and the like cause errors in recorded data in a semiconductor memory chip. The probability of an error occurring in the recorded data is very low. However, recent developments in miniaturization techniques for semiconductors allow an increase in the number of the memory cells per unit area, and thus the probability of the error occurring in data cannot be ignored.

An error correcting mechanism using an Error Correcting Code (ECC) is known as a method for detecting an error in data and correcting the detected error in the data. The ECC is an error correcting code which uses a hamming code according to a length of data to be recorded. In the error correcting mechanism using the ECC, data is stored together with the ECC in a memory. The data and the ECC are read when the data is read from the memory, and any errors in the read data are detected and corrected using the data and the ECC. For example, using an 8-bit ECC for 64-bit data allows a 1-bit error to be corrected.

FIG. 1 is a diagram showing a configuration of a common conventional computer system utilizing the error correcting mechanism with the use of the ECC. A computer system 1000 shown by FIG. 1 uses the 8-bit ECC for the 64-bit data. The computer system 1000 includes a memory module 1001, a chip set 1002, and a CPU 1003. The CPU 1003 sends an instruction for reading and writing data to the chip set 1002. Responding to the instruction from the CPU 1003, the chip set 1002 reads and writes data from and into the memory module 1001. When reading the data, the chip set 1002 reads the 64-bit data and the 8-bit ECC from the memory module 1001, and detects an error in the read data and corrects the detected error in the read data. Furthermore, when writing the data, the chip set 1002 generates the 8-bit ECC based on the 64-bit write data from the CPU 1003, and writes the data and the ECC into the memory module 1001.

The memory module 1001 includes plural memory chips 1004. Each memory chip 1004 includes a bit line 1005 for 8-bit data and a bit line 1006 for a 1-bit ECC. The bit line 1005 for data is used for writing and reading the data by the chip set 1002, and the bit line 1006 for ECC is used for writing and reading the ECC.

However, there is an issue that a memory chip including a bit line for ECC is more costly than a normal memory chip. For this reason, the error correcting mechanism with the ECC is used only for an expensive server system.

On the other hand, a technique concerning a memory control device which performs error correction using the normal memory chip has been disclosed in Japanese Unexamined Patent Application No. 2005-182613 (hereinafter, referred to as Patent Reference 1).

FIG. 2 is a diagram showing a configuration of a computer system including a conventional memory control device described in Patent Reference 1. A computer system 1100 shown by FIG. 2 includes a microcontroller block 1110, a memory control device 1120, and a memory 1130 made up of a normal memory chip. The microcontroller block 1110 sends, to the memory control device 1120, an instruction for reading and writing data from and into the memory 1130. When writing the data, the memory control device 1120 adds an error correcting code 1132 to each 64-bit data 1131 and writes it into the memory 1130. The memory control device 1120 arranges the error correcting code 1132 on a memory map, similar to the data 1131. Moreover, when reading the data, the memory control device 1120 reads the data 1131 and the error correcting code 1132 in chronological order, and corrects an error in the data 1131 using the read error correcting code 1132.

As mentioned above, the memory control device 1120 described in Patent Reference 1 reads and writes the data 1131 and the error correcting code 1132 using the bit line for data. Consequently, the error correction can be performed using the normal memory chip.

However, since the error correcting codes 1132 are added to the data 1131 in an entire region of the memory 1130 in the memory control device 1120 described in Patent Reference 1, the memory 1130 requires a memory capacity for storing the data 1131 and the error correcting codes 1132. This causes a problem that the required memory capacity increases. Therefore, it is difficult to realize the above-described technique with an embedded system having a limited memory capacity.

### SUMMARY OF THE INVENTION

In view of the above problem, the present invention is devised and has an object of providing a memory control device which corrects an error in data and suppresses an increase of a required memory capacity.

In order to achieve the above object, the memory control device according to the present invention is a memory control device which reads data including an error correcting code from a memory, and includes: an error correcting unit which detects an error in data and corrects the detected error in the data, based on the error correcting code, and sends the error detected and error corrected data to the outside; and a selector which selects whether to send the data read from the memory to the error correcting unit or to the outside.

According to this configuration, it is possible that the error correcting unit detects the error in the data to which the error correcting code is added, the data being stored in the memory, corrects the detected error in the data, and sends the error detected and corrected data to the outside. Furthermore, data to which the error correcting code is not added can be sent to the outside without the error being detected and corrected. As a result, the error correcting code is added to data requiring a high reliability and is not added to data not requiring a high reliability, and these data can be stored in the memory. Therefore, a data region of the error correcting code in the data not requiring the high reliability can be reduced, so that the required memory capacity can be reduced when compared with a case where error correcting codes are added to entire data in the memory. In other words, the present invention can provide the memory control device which corrects the error in the data and suppresses the increase of the required memory capacity.

Moreover, it is possible that the memory control device is a memory control device which reads the data including the error correcting code from the memory an instruction received from a microcontroller block including a CPU and that the memory control device further includes an instruction replacing unit which replaces the error correcting code with an instruction unrelated to an operation of the CPU and sends it to the outside.

According to this configuration, the read error correcting code is replaced by the instruction replacing unit with the instruction unrelated to the operation of the CPU, and the instruction is sent to the microcontroller block. Consequently, although a processing for identifying the error correcting code or the like is not performed in the microcontroller block 110, a system operation is not interfered. Accordingly, an amount of processing in the microcontroller block can be reduced.

In addition, it is possible that the memory control device further includes an address converting unit which converts an address inputted from the outside into an address on the memory including a region where the error correcting code is stored.

According to this configuration, an external device can read the error detected and corrected data without designating an address in consideration of the region where the error correcting code is stored. Therefore, since the external device can access the data without considering a regional portion of the error correcting code, an amount of processing in the external device can be reduced.

Furthermore, it is possible that the memory control device is a memory control device which reads the data including the error correcting code from the memory with an instruction received from a microcontroller block including a CPU, that the selector sends the data read from the memory to the error correcting unit, in the case where an instruction reading signal which becomes the first logic when reading program data by the microcontroller block is the first logic, and sends the data read from the memory to the microcontroller block, in the case where the instruction reading signal is not the first logic, and that the address converting unit converts the address inputted from the microcontroller block into the address on the memory including the region where the error correcting code is stored.

According to this configuration, only when reading an instruction by the microcontroller block, the address converting unit performs address conversion and the error correcting unit detects the error in the data and corrects the detected error in the data. As a result, the error correcting code is added only to the program data requiring the high reliability, and the program data can be stored in the memory.

Moreover, it is possible that the memory control device further includes: an error correcting code generating unit which generates an error correcting code to data inputted from the outside; an address determining unit which determines whether or not an address inputted from the outside is included in a predetermined address range; and the second selector which sends the data inputted from the outside to the error correcting code generating unit, in the case where it is determined by the address determining unit that the address inputted from the outside is included in the predetermined address range, and sends the data to the memory, in the case where it is determined by the address determining unit that the address inputted from the outside is not included in the predetermined address range, that the selector sends the data read from the memory to the error correcting code unit, in the case where it is determined by the address determining unit that the address inputted from the outside is included in the predetermined address range, and sends the data read from the memory to the outside, in the case where it is determined by the address determining unit that the address inputted from the outside is not included in the predetermined address range, and that the address converting unit converts the address inputted from the outside into the address on the memory including the region where the error correcting code is stored, in the case it is determined by the address determining unit that the address inputted from the outside is included in the predetermined address range.

According to this configuration, depending on whether or not the address inputted from the outside is within the predetermined address of the memory, the error correcting unit detects the error in the data and corrects the detected error in the data. Consequently, the error correcting code is added to not only the program data but also significant data having an impact on a system operation such as stack data of a program, and these data can be stored in the memory. Accordingly, the significant data having the impact on the system operation is protected with the error correcting code, so that robustness of the system can be enhanced. Furthermore, a region to which the error correcting code is necessarily added can be confined to the predetermined address range in the memory, so that the required memory capacity can be reduced.

In addition, it is possible that the memory control device further includes an address storing unit which holds, as a fixed value, a value for determining the predetermined address range and that the address determining unit determines whether or not the address inputted from the outside is included in the predetermined address range, based on the value for determining the predetermined address ranged held in the address storing unit.

According to this configuration, it is possible to freely set, for each system, an address range where data to which the error correcting code is added is stored, the address range being in the memory, and this allows application to various devices.

Furthermore, it is possible that the memory control device further includes the address storing unit which holds a value for determining a predetermined address range inputted from the outside and that the address determining unit determines whether or not the address inputted from the outside is included in the predetermined address range, based on the value for determining the predetermined address held in the address storing unit.

According to this configuration, it is possible to freely set, for each system, the address range where the data to which the error correcting code is added is stored, the address range being in the memory, and this allows the application to the various devices.

Additionally, it is possible that the memory control device is a memory control device which reads the data including the error correcting code from the memory with at least an instruction received from a Direct Memory Access Controller (DMAC) and that the selector sends the data and the error correcting code read from the memory to the DMAC, in the case where an instruction for reading is from the DMAC.

According to this configuration, in the case where contents of the memory are dumped from external debug software, detection of the error in the data and correction of the detected error in the data can be performed with the debug software without using the error correcting unit. As a result, the data held in the memory can be dumped correctly with the debug software.

Moreover, it is possible that the memory control device is a memory control device which reads the data including the error correcting code from the memory with an instruction received from the microcontroller block including the CPU and the DMAC, that the selector sends the data read from the memory to the error correcting unit, in the case where an instruction reading signal which becomes the first logic when reading the program data by the microcontroller block is the first logic or in the case where a DMAC reading signal which becomes the second signal when reading the data by the DMAC, and sends the data read from the memory to the microcontroller block or the DMAC, in the case where the instruction signal is not the first logic and the DMAC reading signal is not the second logic.

According to this configuration, in the case where the contents of the memory is dumped from the external debug software, when the DMAC reading signal is assumed as a control signal, the detection of the error in the data and the correction of the detected error in the data are performed in the memory control device. Accordingly, it is unnecessary to perform a processing of detecting the error in the data and correcting the detected error in the data, so that an amount of the processing with the debug software can be reduced.

In addition, it is possible that the memory control device is a memory control device which reads the data including the error correcting code from the memory with the instruction received from the microcontroller block including the CPU, that the microcontroller block includes: a bus control unit which assigns an instruction from the CPU into either the memory control device or another device; and a register which holds information for determining a destination of the instruction for the bus control unit, and that the memory control device further includes a register setting changing unit which changes the information held in the register, in the case where the error correcting unit detects the error in the data.

According to this configuration, in the case where the error in the read data is detected, the program data is read from a program ROM arranged on a system bus different from a memory bus or the like without using the program data originally on the memory, and the processing can be performed. That is, it is possible to perform the processing without using the memory in which the error occurred, so that the robustness of the system can be enhanced.

Furthermore, it is possible that the memory control device is a memory control device which reads the data including the error correcting code from the memory with the instruction received from the microcontroller block including the CPU, that the CPU includes a register which holds information indicating an arranged position of a program, and that the memory control device further includes the register setting changing unit which changes the information held in the register, in the case where the error correcting unit detects the error in the data.

According to this configuration, in the case where the error in the read data is detected, the program data is read from the program ROM arranged on the system bus different from the memory bus or the like without using the program data originally on the memory, and the processing can be performed. In other words, it is possible to perform the processing without using the memory in which the error occurred, so that the robustness of the system can be enhanced.

Moreover, the computer system according to the present invention includes: a memory control device which reads data including an error correcting code from a memory; a data region inserting unit which inserts a data region having a predetermined size into an object which is a compiled program source; an address resolution unit which performs address resolution on an operand of the object including the data region inserted by the data region inserting unit; an error correcting code computing unit which computes an error correcting code of the object; and an error correcting code writing unit which writes the error correcting code computed by the error correcting code computing unit into the data region. The memory control device writes, into the memory, the object including the data region into which the error correcting code is written by the error correcting code writing unit, and includes: an error correcting unit which detects the error in the data and corrects the detected error in the data, based on the error correcting code, and sends the error detected and error corrected data to the outside; and a selector which selects whether to send the data read from the memory to the error correcting unit or to the outside.

According to this configuration, even when the error correcting code is added, the address resolution is performed on the operand of the object in consideration of the region of the error correcting code. As a result, the external device can access the data held in the memory without performing the address conversion.

Additionally, the computer system according to the present invention includes: a memory; a memory control device which writes and reads data including an error correcting code into and from the memory; and a microcontroller block which sends, to the memory control device, an instruction for writing and reading the data into and from the memory. The memory control device includes: an error correcting unit which detects the error in the data and corrects the detected error in the data, based on the error correcting code, and sends the error detected and error corrected data to the outside; and a selector which selects whether to send the data read from the memory to the error correcting unit or to the outside.

According to this configuration, it is possible that the error correcting unit detects the error in the data to which the error correcting code is added, the data being stored in a memory, corrects the detected error in the data, and sends the error detected and corrected data to the outside. Furthermore, data to which the error correcting code is not added can be sent to the outside without the error being detected and corrected. Consequently, the error correcting code is added to data requiring a high reliability and is not added to data not requiring a high reliability, and these data can be stored in the memory. Therefore, a data region of the error correcting code in the data not requiring the high reliability can be reduced, so that the required memory capacity can be reduced when compared with a case where error correcting codes are added to entire data in the memory. That is, the present invention can provide the memory control device which corrects the error in the data and suppresses the increase of the required memory capacity.

Furthermore, the data reproducing and recording device according to the present invention includes: a memory control device which reads data including an error correcting code from a memory; a data region inserting unit which inserts a data region having a predetermined size into an object which is a compiled program source; an address resolution unit which performs address resolution on an operand of the object including the data region inserted by the data region inserting unit; an error correcting code computing unit which computes an error correcting code of the object; and an error correcting code writing unit which writes the error correcting code computed by the error correcting code computing unit into the data region. The memory control device writes, into the memory, the object including the data region into which the error correcting code is written by the error correcting code writing unit, and includes: an error correcting unit which detects the error in data and corrects the detected error in the data, based on the error correcting code, and sends the error detected and error corrected data to the outside; and a selector which selects whether to send the data read from the memory to the error correcting unit or to the outside.

According to this configuration, it is possible that the error correcting unit detects the error in the data to which the error correcting code is added, the data being stored in a memory, corrects the detected error in the data, and sends the error detected and corrected data to the outside. Furthermore, data to which the error correcting code is not added can be sent to the outside without the error being detected and corrected. Consequently, the error correcting code is added to the data requiring a high reliability and is not added to data not requiring the high reliability, and these data can be stored in the memory. Therefore, a data region of the error correcting code in the data not requiring the high reliability can be reduced, so that the required memory capacity can be reduced when compared with a case where error correcting codes are added to entire data in the memory. In other words, the present invention can provide the data reproducing and recording device which corrects the error in the data and suppresses the increase of the required memory capacity.

Moreover, the method for generating program data according to the present invention is a method for generating the program data to be written into a memory by a memory control device. The memory control device is a memory control device which reads data including an error correcting code from the memory, and includes: an error correcting unit which detects an error in the data and corrects the detected error in the data, based on the error correcting code, and sends the error detected and error corrected data to the outside; and a selector which selects whether to send the data read from the memory to the error correcting unit or to the outside. The method for generating the program data includes the steps of: inserting a data region having a predetermined size into an object which is a compiled program source; performing address resolution on an operand of the object including the data region inserted in the inserting; computing an error correcting code of the object; and writing the error correcting code computed in the computing into the data region.

Accordingly, even when the error correcting code is added, the address resolution is performed on the operand of the object in consideration of the region of the error correcting code. As a result, the external device can access the data held in the memory without performing the address conversion.

As mentioned above, the present invention can provide the memory control device which corrects the error in the data and suppresses the increase of the required memory capacity.

### FURTHER INFORMATION ABOUT TECHNICAL BACKGROUND TO THIS APPLICATION

The disclosure of Japanese Patent Application No. 2006-322471 filed on Nov. 29, 2006 including specification, drawings and claims is incorporated herein by reference in its entirety.

### BRIEF DESCRIPTION OF THE DRAWINGS

These and the other objects, advantages and features of the invention will become apparent from the following description thereof taken in conjunction with the accompanying drawings which illustrate a specific embodiment of the invention. In the drawings:

FIG. 1 is a diagram showing a configuration of a conventional computer system.

FIG. 2 is a diagram showing a configuration of a conventional computer system.

FIG. 3 is a diagram showing a configuration of a computer system according to a first embodiment of the present invention.

FIG. 4 is a flow chart showing a flow of a method for generating a program image in the computer system according to the first embodiment of the present invention.

FIG. 5 is a diagram showing the method for generating the program image in the computer system according to the first embodiment of the present invention.

FIG. 6 is a diagram showing a configuration of a computer system according to a second embodiment of the present invention.

FIG. 7 is a diagram showing a configuration of an address converting unit in the computer system according to a second embodiment of the present invention.

FIG. 8 is a simplified view showing a relationship between a memory address of a memory and an access request address.

FIG. 9 is a simplified view showing a relationship between a memory address of a memory and an access request address.

FIG. 10 is a diagram showing a configuration of a computer system according to a third embodiment of the present invention.

FIG. 11 is a diagram showing a configuration of a computer system according to a fourth embodiment of the present invention.

FIG. 12 is a diagram showing a configuration of a computer system according to a fifth embodiment of the present invention.

FIG. 13 is a diagram showing a configuration of a computer system according to a sixth embodiment of the present invention.

FIG. 14 is a diagram showing a configuration of a computer system according to a seventh embodiment of the present invention.

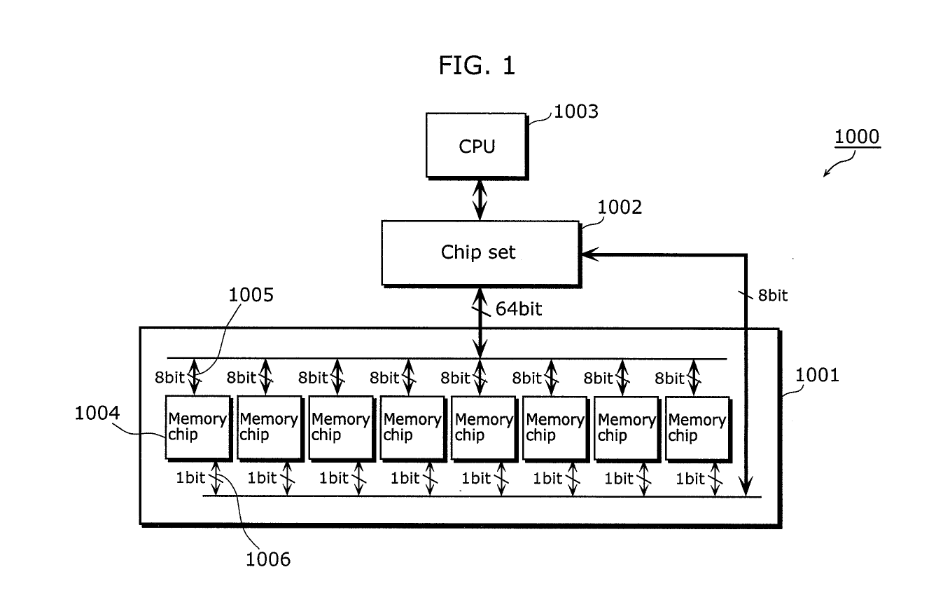

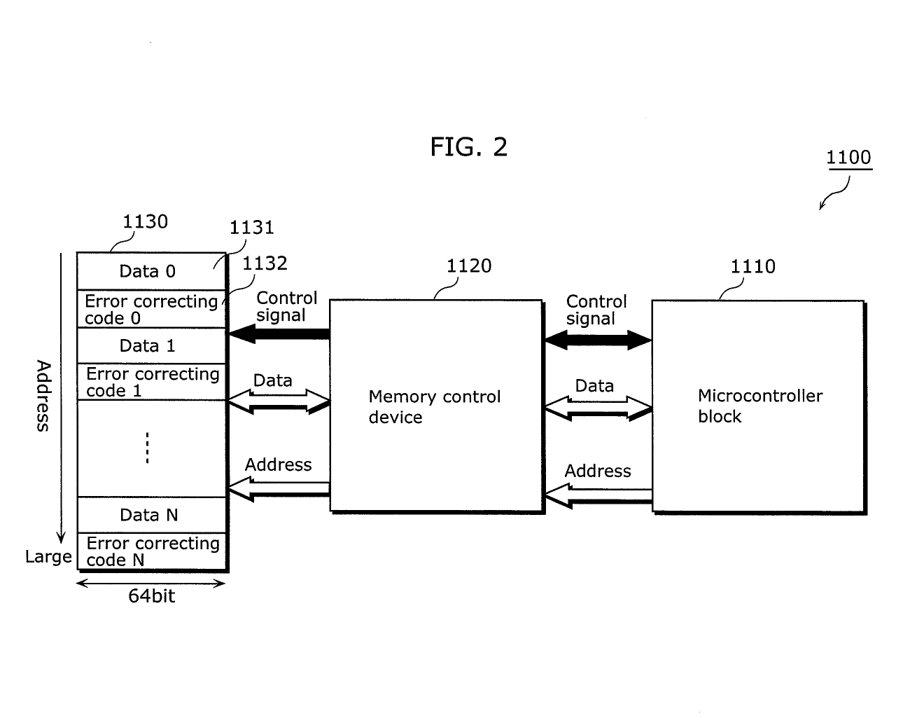

### DESCRIPTION OF THE PREFERRED EMBODIMENT(S)

Hereinafter, a memory control device according to embodiments of the present invention is described with reference to the drawings.

### First Embodiment

A memory control device according to a first embodiment of the present invention selectively detects an error in data and corrects the detected error in the data read from a memory. This allows reading of data to which an error correcting code is added and data to which an error correcting code is not added from the memory.

First, a configuration of the memory control device according to the first embodiment of the present invention is described.

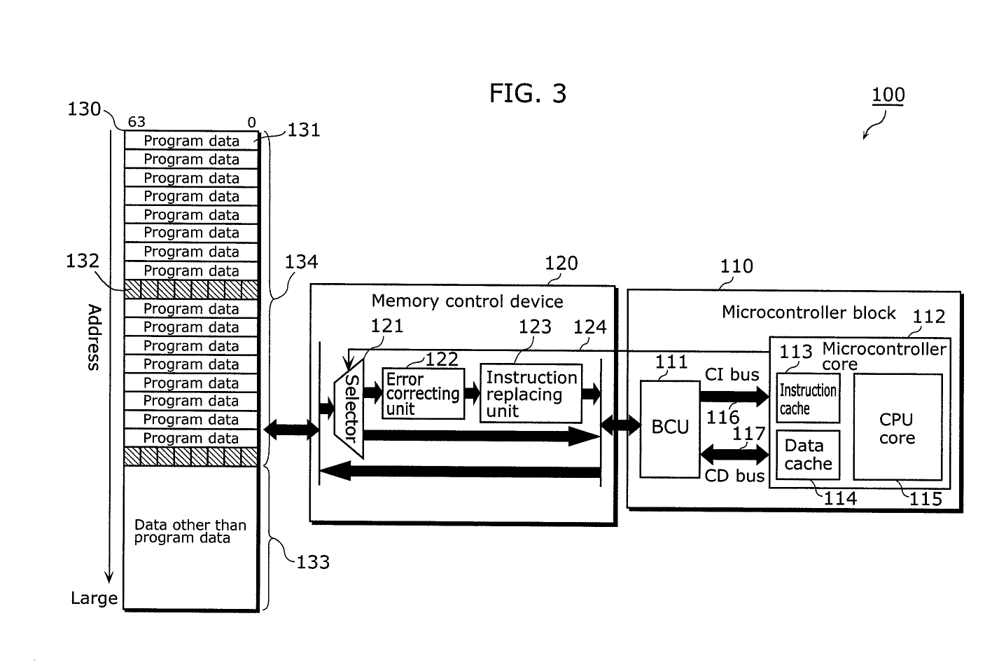

FIG. 3 is a diagram showing a configuration of a computer system having the memory control device according to a first embodiment of the present invention.

A computer system 100 shown by FIG. 3 is, for example, a computer system used for a data reproducing and recording device, such as a DVD recorder. The computer system 100 includes a microcontroller block 110, a memory control device 120, and a memory 130.

The memory 130 is, for example, a RAM which allows reading and writing of data per 64 bits. The memory 130 holds plural program data 131, error correcting codes 132 corresponding to respective program data 131, and data other than a program 133. Here, the data other than the program 133 is, for example, data that does not require the error correction, such as video data and audio data.

The microcontroller block 110 sends, to the memory control device 120, an instruction for reading and writing data from and into the memory 130. The microcontroller block 110 includes a Bus Control Unit (BCU) 111, a microcontroller core 112, a CPU core 115, a CI bus 116, and a CD bus 117.

The bus control unit 111 controls the CI bus 116 and the CD bus 117.

The microcontroller core 112 generates an instruction reading signal 124 that becomes active in a case of an instruction for reading program data (when reading the instruction). The microcontroller core 112 includes an instruction cache 113 and a data cache 114. The instruction cache 113 holds an instruction for the memory control device 120 and the like. The data cache 114 holds data to be written into or data read from according to the instruction. The CPU core 115 controls instruction issuance and the like of the microcontroller block 110.

The CI bus 116 is a bus between the instruction cache 113 and the bus control unit 111. The CD bus 117 is a bus between the data cache 114 and the bus control unit 111.

The memory control device 120 writes and reads the program data 131, the error correcting code 132, and the data other than the program 133 into and from the memory 130 with an instruction received from the microcontroller block 110. The memory control device 120 includes a selector 121, an error correcting unit 122, and an instruction replacing unit 123.

In response to the instruction reading signal 124, the selector 121 selects whether to send the data read from the memory 130 (the program data 131, the error correcting code 132, and the data other than the program 133) to the error correcting unit 122 or to the microcontroller block 110. Specifically, in the case where the instruction reading signal 124 is active, the selector 121 sends the data read from the memory 130 to the error correcting unit 122. In the case where the instruction reading signal 124 is non-active, the selector 121 sends, not via the error correcting unit 122 and the instruction replacing unit 123, the data read from the memory 130 to the microcontroller block 110.

The error correcting unit 122 detects an error in the program data 131 read from the memory 130 and corrects the detected error in the read program data 131, based on the program data 131 and the error correcting code 132 read from the memory 130. The error correcting unit 122 sends the error detected and error corrected program data 131 and the error correcting code 132 to the instruction replacing unit 123.

The instruction replacing unit 123 replaces the error correcting code 132 sent by the error correcting unit 122 with an instruction unrelated to an operation of the CPU core 115, and sends it to the microcontroller block 110. For example, the instruction replacing unit 123 replaces the error correcting code 132 with a nop instruction, and sends it to the microcontroller block 110. Furthermore, the instruction replacing unit 123 sends, to the microcontroller block 110, the data in which the error correcting unit 122 corrected the error. It should be noted that the error correcting unit 122 may send, not via the instruction replacing unit 123, to the microcontroller block 110, the error detected and corrected program data 131.

Next, an operation of the computer system 100 is described.

First, an operation of writing the program data 131 into the memory 130 is described.

The microcontroller block 110 generates a program image 134 that is the program data 131 to which the error correcting code 132 is added, the program data 131 being to be written into the memory 130. Hereinafter, a processing of generation of the program image 134 by the microcontroller block 110 is described in detail. For example, the microcontroller block 110 generates the program image 134 through a software process.

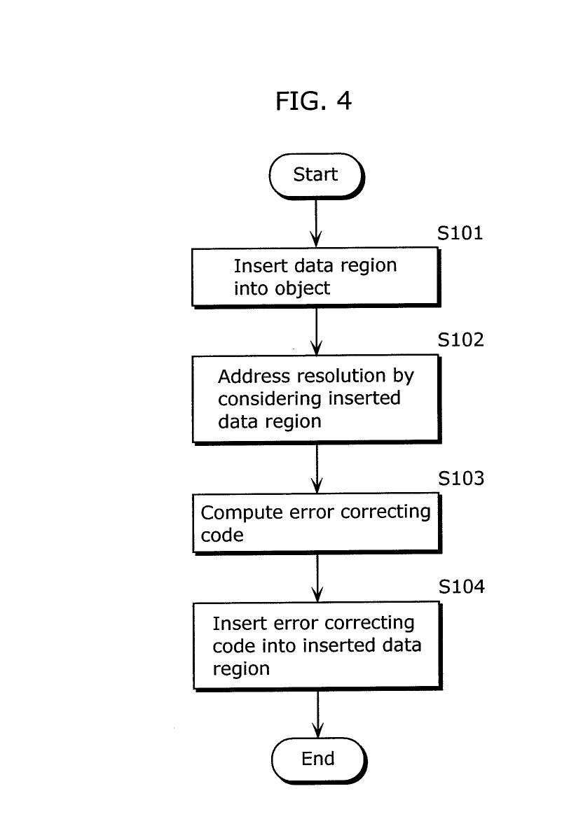

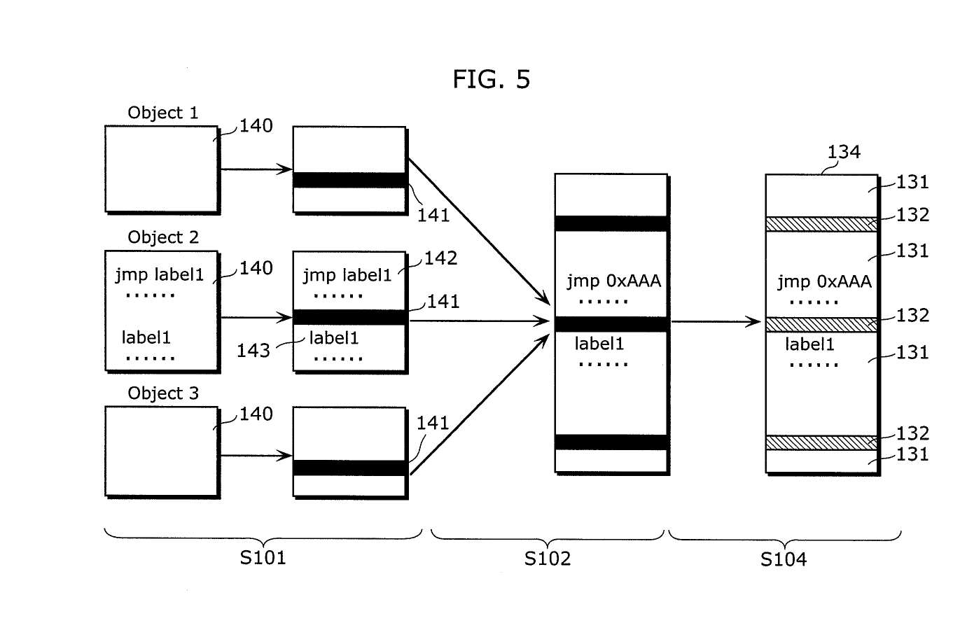

FIG. 4 is a flow chart showing a flow of a method for generating the program image 134 to be arranged in the memory 130. FIG. 5 is a diagram showing a method for generating the program image 134.

First, the microcontroller block 110 inserts a data region 141 having a predetermined size into each object 140 having a predetermined size after a program source is compiled (S 101). For example, as shown by FIG. 5, the data region 141 is inserted between a jmp instruction 142 and a label 143 which indicates a jump address of the jmp instruction 142. Here, a size of the data region having the predetermined size is equal to a size of the error correcting code 132, the size of the error correcting code corresponding to the object having the predetermine size. For example, the object 140 having the predetermined size is a 512-bit object, and the data region 141 having the predetermined size is a 64-bit data region. Next, the microcontroller block 110 performs an address resolution on an operand of the object 140 which includes the data region 141 inserted in S 101 (S 102). Specifically, in an example shown by FIG. 5, the address resolution is performed on an operand of the jmp instruction 142 in consideration of a distance from a location of the jmp instruction 142 to the label 143 including a regional portion of the data region 141 having the predetermined size. Subsequently, the microcontroller block 110 computes the error correcting code 132 for each object 140 having the predetermined size (S 103). Finally, the microcontroller block 110 writes the error correcting code 132 computed in S 103 into the data region 141 (S 104).

The program image 134 in which the error correcting code 132 corresponding to the program data having the predetermined size is arranged for each program data 131 having the predetermined size is generated through the above processing.

Furthermore, in S 102, since the address resolution is performed in consideration of the regional portion of the data region 141, even in the case where the error correcting code 132 is written into the data region 141, the size of the data region 141 having the predetermined size and the size of the error correcting code 132 are the same. Thus, the operand of the jmp instruction 142 is in the state where the address resolution is performed in consideration of a regional portion of the error correcting code 132.

Then, the microcontroller block 110 sends the generated program image 134 and an instruction for writing to the memory control device 120. The memory control device 120 writes the program image 134 into the memory 130. Based on the above, the program data 131 to which the error correcting code 132 is added is written into the memory 130.

Next, an operation of writing the data other than the program 133 into the memory 130 is described.

The microcontroller block 110 sends the data other than the program 134 and an instruction for writing to the memory control device 120. The memory control device 120 writes the data other than the program 133 into the memory 130. Based on the above, the data other than the program data 133 to which the error correcting code 132 is not added is written into the memory 130.

Next, an operation of reading the program data 131 from the memory 130 is described.

The microcontroller block 110 sends an instruction for reading the program data 131 to the memory control device 120. Moreover, the microcontroller block 110 has the instruction reading signal 124 active.

The memory control device 120 reads the program data 131 and the error correcting code 132 corresponding to the program data 131 with an instruction received from the microcontroller block 110. Since the instruction reading signal 124 is active, the selector 121 sends, to the error correcting unit 122, the read program data 131 and the read error correcting code 132.

The error correcting unit 122 detects an error in the program data 131 and corrects the detected error in the program data 131, based on the program data 131 and the error correcting code 132. The instruction replacing unit 123 replaces the error correcting code 132 sent by the error correcting unit 122 with an instruction unrelated to an operation of the CPU core 115, and sends it to the microcontroller block 110. In addition, the instruction replacing unit 123 sends, to the microcontroller block 110, the program data 131 in which the error correcting unit 122 corrected the error.

Based on the above, the program data 131 is read from the memory 130. Furthermore, in the case where the error occurs, the program data 131 in which the error correcting unit 122 corrected the error is read.

Next, an operation of reading the data other than the program 133 from the memory 130 is described.

The microcontroller block 110 sends an instruction for reading the data other than the program 133 to the memory control device 120. Moreover, the microcontroller block 110 has the instruction reading signal 124 non-active.

The memory control device 120 reads the data other than the program data 133 with an instruction received from the microcontroller block 110. Since the instruction reading signal 124 is non-active, the selector 121 sends, not via the error correcting unit 122 and the instruction replacing unit 123, the data other than the program data 133 to the microcontroller block 110. Based on the above, the data other than the program 133 is read from the memory 130.

As mentioned above, the memory control device 120 according to the first embodiment of the present invention detects the error in the program data 131 to which the error correcting code 132 stored in the memory 130 is added, corrects the detected error, and sends, to the microcontroller block 110, the error detected and error corrected program data 131. Additionally, the data other than the program 133 to which the error correcting code 132 is not added is sent to the microcontroller block 110 without the error being detected and corrected, the data other than the program 133 being stored in the memory 130. As a result, the error correcting code 132 is added to the program data 131 requiring a high reliability and the error correcting code 132 is not added to the data other than the program 133 not requiring a high reliability, and these data can be stored in the memory 130. Therefore, a data region of the error correcting code 132 in the data other than the program 133 not requiring the high reliability can be reduced, so that the required memory capacity can be reduced when compared with a case where error correcting codes are added to entire data in a memory. In other words, the present invention can provide the memory control device 120 which corrects the error and suppresses an increase of the required memory capacity. In addition, the present invention can provide the computer system 100 which corrects the error and suppresses the increase of the required memory capacity. Further, the present invention can realize a data reproducing and recording device including the computer system 100, such as a DVD recorder, in which the increase of the required memory capacity is suppressed.

Moreover, the address resolution is performed on the program image 134 to be written into the memory 130 in consideration of the regional portions of the error correcting codes 132. Consequently, the microcontroller block 110 does not need to consider addresses for the regional portions of the error correcting codes 132. That is, the microcontroller block 110 can access the data held in the memory 130 without performing address conversion.

In addition, the instruction replacing unit 123 replaces the read error correcting code 132 with an instruction unrelated to an operation of the CPU core 115, and sends it to the microcontroller block 110. This way, although a processing for identifying the error correcting code 132 or the like is not performed in the microcontroller block 110, a system operation is not interfered.

Furthermore, the selector 121 is controlled with the instruction reading signal 124, the instruction reading signal 124 being active when reading an instruction. As a result, it is possible that the error correcting code 132 is added only to the program data 131 requiring the high reliability and that the program data 131 can be stored in the memory.

It should be noted that although the address resolution of the jmp instruction 142 is described as an example in FIG. 5, concerning other instruction for referencing an address on the memory (for example, branch instruction and the like), even in the case where the data region 141 is inserted between the instruction and the reference address, the same address resolution may be performed.

Additionally, in the above description, although microcontroller block 110 generates the program image 134 to be arranged in the memory 130 through the processing shown by FIG. 4, an external computer system may generate the program image 134 and write it into the memory 130 with a special writing program to be executed in the microcontroller block 110 or debug software.

Furthermore, in the above description, although reading and writing the data per 64 bits are performed in the memory 130, the configuration of the memory 130 is not limited to this. Reading and writing the data per byte or per word (per plural bytes) may be performed in the memory 130.

Moreover, it is possible that the size of the error correcting code 132 corresponding to the program data 131 having the predetermined size is settable to a predetermined size, the program data 131 being to be held in the memory 130.

### Second Embodiment

A memory control device according to a second embodiment of the present invention converts an address from a microcontroller block into an address on a memory in consideration of a region where an error correcting code is held. This allows the microcontroller block to access data to which the error correcting code is added, similar to accessing a normal memory.

First, a configuration of the memory control device according to the second embodiment of the present invention is described.

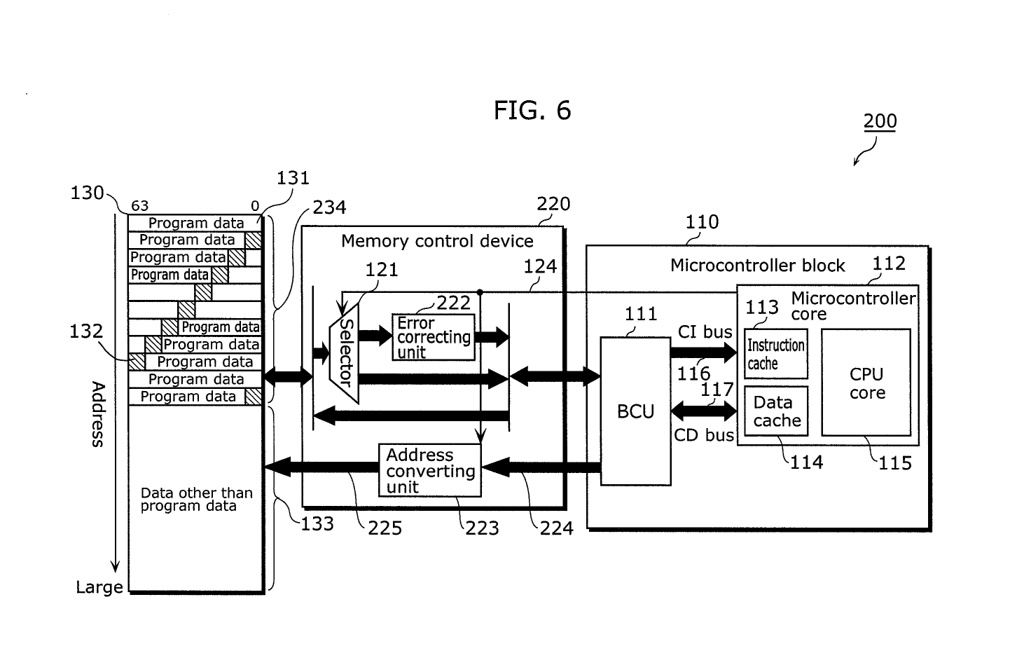

FIG. 6 is a diagram showing a configuration of a computer system having the memory control device according to the second embodiment of the present invention. A computer system 200 shown by FIG. 6 differs from the computer system 100 according to the first embodiment shown by FIG. 3 in a configuration of a memory control device 220. It should be noted that the same numeral references are given to the same components as in FIG. 3 and are not described in detail.

The memory control device 220 includes a selector 121, an error correcting unit 222, and an instruction replacing unit 223.

In response to an instruction reading signal 124, the selector 121 selects whether to send data read from a memory 130 (program data 131, an error correcting code 132, and data other than a program 133) to the error correcting unit 222 or to a microcontroller block 110. Specifically, in the case where the instruction reading signal 124 is active, the selector 121 sends the data read from the memory 130 to the error correcting unit 222. In the case where the instruction reading signal 124 is non-active, the selector 121 sends, not via the error correcting unit 222, the data read from the memory 130 to the microcontroller block 110.

The error correcting unit 222 detects an error in the program data 131 read from the memory 130 and corrects the detected error in the read program data 131, based on the program data 131 and the error correcting code 132 read from the memory 130. Furthermore, the error correcting unit 222 sends, to the microcontroller block 110, the error detected and corrected program data 131. It should be noted that the error correcting unit 222 does not output the error correcting code 132 to the microcontroller block 110.

The address converting unit 223 converts an access request address 224 inputted from the microcontroller block 110 into a memory address 225 on the memory 130 which includes a region where the error correcting code 132 is stored. In addition, the address converting unit 223 is controlled with the instruction reading signal 124. Specifically, in the case where the instruction reading signal 124 is active, the address converting unit 223 converts the access request address 224 into the memory address 225 on the memory 130 according to a predetermined formula. In the case where the instruction reading signal 124 is non-active, the address converting unit 223 sends the access request address 224 to the memory 130 without converting it.

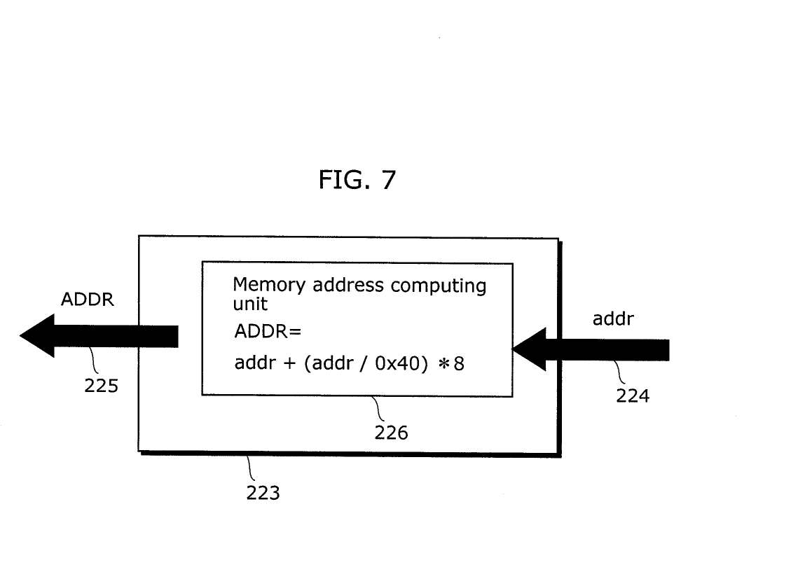

FIG. 7 is a detailed configuration of the address converting unit 223.

The address converting unit 223 includes a memory address computing unit 226. The memory address computing unit 226 converts the access request address 224 into the memory address 225 on the memory 130 using the predetermined formula.

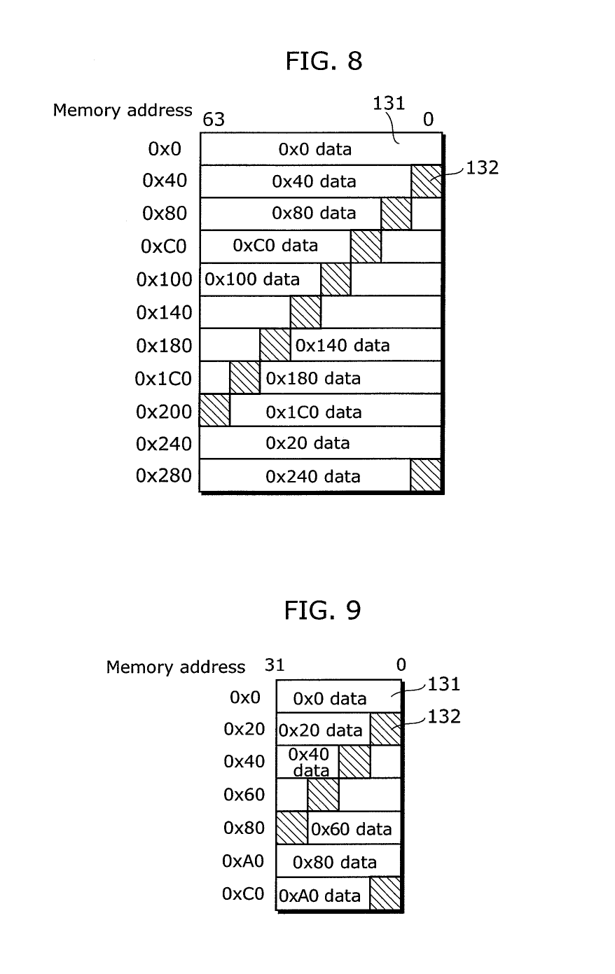

FIG. 8 is a simplified view showing a relationship between the memory address 225 of the memory 130 and the access request address 224.

In FIG. 8, the memory 130 has a 64-bit data width, and an 8-bit error correcting code 132 is added to each 64-bit data. Accordingly, an 8-bit shift occurs for each 0×40 bit of the access request address 224 in the memory address 225. Consequently, the memory address computing unit 226 computes the memory address 225 using the below formula (1).

ADDR=addr+(addr/0×40)×8 (1)

Here, ADDR indicates the memory address 225, and addr indicates the access request address 224. Furthermore, (addr/0×40) is a quotient obtained by diving addr by 0×40. Moreover, addresses of 0×40 and the like are bit unit addresses. For example, according to the above formula (1), in the case where the access request address 224 is 0×40, the memory address 225 is 0×48.

It should be noted that a formula used by the memory address computing unit 226 is determined by whether the error correcting code 132 is added every data width of the memory 130 or every number of bits of data. FIG. 9 is a simplified view showing a relationship between the memory address 225 of the memory 130 and the access request address 224, in the case where the data width is 32 bits and the 8-bit error correcting code 132 is added to each 32-bit data. For example, as shown by FIG. 9, in the case where the data width of the memory 130 is 32 bits and the 8-bit error correcting code 132 is added to each 32-bit data, only the 8-bit shift occurs for each 0×20 bit of the access request address 224 in the memory address 225. Accordingly, a formula executed by the memory address computing unit 226 is the below formula (2).

ADDR=addr+(addr/0×20)×8 (2)

In other words, even a data bus width of the memory 130 varies, the memory address 225 can be computed by the same token.

It should be noted that although a bit unit address is used as the access request address 224 and the memory address 225 in the above description, a byte unit or plural byte units (word units) address may be acceptable.

Next, an operation of reading the program data 131 from the memory 130 is described. It should be noted that the access request address 224 is assumed as 0×40.

First, the microcontroller block 110 sends an instruction for reading the program data 131 to the memory control device 220. The microcontroller block 110 sends 0×40 as the access request address 224 which is the address of the program data 131 to be read. In addition, the microcontroller block 110 has the instruction reading signal 124 active.

Since the instruction reading signal 124 is active, the address converting unit 223 converts the access request address 224 into the memory address 225 on the memory 130. The memory address computing unit 226 converts the access request address 224 using the above formula (1) and computes 0×48 as the memory address 225. The memory control device 220 reads the program data 131 of the computed memory address 225 (0×48). The memory control device 220 reads the error correcting code 132 corresponding to the read program data 131 (for example, data of 0×88 which is the memory address 225 is read.).

Since the instruction reading signal 124 is active, the selector 121 sends, to the error correcting unit 222, the read program data 131 and the read error correcting code 132.

The error correcting unit 222 detects an error in the program data 131 and corrects the detected error in the program data 131, based on the program data 131 and the error correcting code 132. The error correcting unit 222 sends, to the microcontroller block 110, the error detected and error corrected program data 131.

Based on the above, the program data 131 is read from the memory 130. Furthermore, in the case where the error occurs, the program data 131 in which the error correcting unit 122 corrected the error is read.

Next, an operation of reading the data other than the program 133 from the memory 130 is described.

The microcontroller block 110 sends an instruction for reading the data other than the program 133 to the memory control device 220. Moreover, the microcontroller block 110 has the instruction reading signal 124 non-active.

Since the instruction reading signal 124 is non-active, the memory address computing unit 226 does not convert the access request address 224. The memory control device 220 reads the data other than the program 133, handling the access request address 224 as the memory address 225.

Since the instruction reading signal 124 is non-active, the selector 121 sends the read data other than the program 133 to the microcontroller block 110. Based on the above, the data other than the program 133 is read from the memory 130.

Next, an operation of writing the program data 131 into the memory 130 is described. It should be noted that the access request address 224 is assumed as 0×40.

First, the microcontroller block 110 sends an instruction for writing the program data 131 to the memory control device 220. The microcontroller block 110 sends 0×40 as the access request address 224 which is the address of the program data 131 to be written. In addition, the microcontroller block 110 has the instruction reading signal 124 active.

Since the instruction reading signal 124 is active, the address converting unit 223 converts the access request address 224 into the memory address 225 on the memory 130. The memory address computing unit 226 converts the access request address 224 using the above formula (1) and computes 0×48 as the memory address 225. The memory control device 220 reads the program data 131 of the computed memory address 225 (0×48), the program data 131 being in prior to writing the data. The memory control device 220 computes program data 131 to be written into the memory 130 (for example, 64 bits) and the error correcting code 132 (for example, 8 bits), based on the read program data 131 (for example, 64 bits) and program data 131 designated by the instruction for writing (for example, 8 bits). The memory control device 120 writes the computed program data and the error correcting code 132 into the memory 130. Based on the above, the program data 131 to which the error correcting code 132 is added is written into the memory 130. It should be noted that generation of the error correcting code 132 in writing is described in a third embodiment later.

Next, an operation of writing the data other than the program 133 into the memory 130 is described.

The microcontroller block 110 sends an instruction for writing the data other than the program 133 to the memory control device 220. Furthermore, the microcontroller block 110 has the instruction reading signal 124 non-active.

Since the instruction reading signal 124 is non-active, the memory address computing unit 226 does not convert the access request address 224. The memory control device 220 writes the data other than the program 133 into the memory 130, handling the access request address 224 as the memory address 225. Based on the above, the data other than the program 133 to which the error correcting code 132 is not added is written into the memory 130.

As mentioned above, in the computer system 200 according to the second embodiment of the present invention, when accessing, from the microcontroller block 110, the program image 234 on which the address resolution is not performed, the address converting unit 223 performs address correction on regional portions of the error correcting codes 132, the program image 234 including regions of the error correcting codes 132. This allows the microcontroller block to access the program data 131 without considering the regional portions of the error correcting codes 132. Accordingly, an amount of processing in the microcontroller block 110 can be reduced.

Moreover, in the computer system 200 according to the second embodiment of the present invention, only when the microcontroller block 110 reads an instruction, the address converting unit 223 performs the address conversion and the error correcting unit 222 detects the error and corrects the detected error. As a result, it is possible that the error correcting code 132 is added only to the program data 131 and that the program data 131 can be stored in the memory 130.

Additionally, the computer system 200 according to the second embodiment of the present invention adds the error correcting code 132 only to the program data 131 requiring a high reliability and writes it into the memory 130. Furthermore, without adding the error correcting code 132 to the data other than the program 133 such as video data and audio data not requiring the error correcting code 132, the computer system 200 writes it into the memory 130. Therefore, a data region of the error correcting code 132 in the data other than the program 133 can be reduced, so that the required memory capacity can be reduced when compared with a case where the error correcting codes 132 are added to entire data in a memory.

### Third Embodiment

A memory control device according to a third embodiment of the present invention judges whether data to be written or to be read is data to which an error correcting code was added or not using an address from a microcontroller block. Consequently, the microcontroller block can specify whether or not the error correcting code is added to simply by specifying only the address and hold the data in a memory.

First, a configuration of the memory control device according to the third embodiment of the present invention is described.

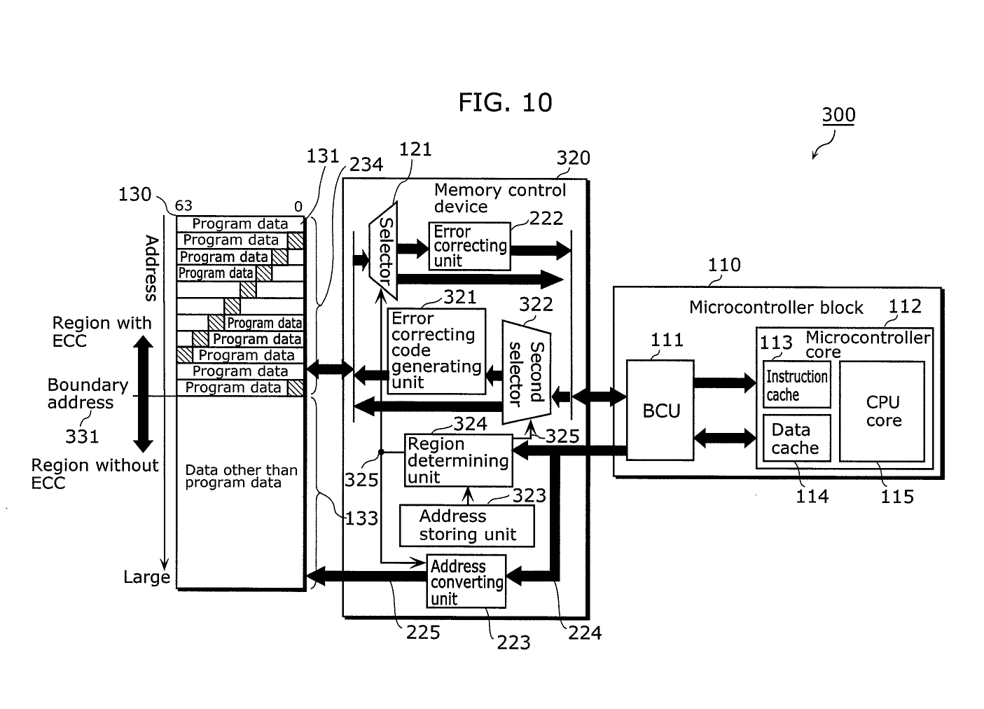

FIG. 10 is a diagram showing a configuration of a computer system including the memory control device according to the third embodiment of the present invention. A computer system 300 shown by FIG. 10 differs from the computer system 200 according to the second embodiment shown by FIG. 6 in a configuration of a memory control device 320. It should be noted that the same numeral references are given to the same components as in FIG. 5 and are not described in detail.

The memory control device 320 includes a selector 121, an error correcting unit 222, an address converting unit 223, an error correcting code generating unit 321, a second selector 322, an address storing unit 323, and a region determining unit 324.

The error correcting code generating unit 321 generates the error correcting code to write data inputted from the microcontroller block 110.

The address storing unit holds a boundary address 331 on the memory 130 as a fixed value. The boundary address 331 is a value for determining an address range for a region where data to which the error correcting code 132 is added is stored. For example, as shown by FIG. 10, in the memory 130, addresses smaller than a value of the boundary address 331 are considered as a region with ECC where the data to which the error correcting code 132 is added is stored, and addresses larger than the value of the boundary address 331 are considered as a region without ECC where the data to which the error correcting code 132 is not added is stored.

The region determining unit 324 determines whether or not an access request address 224 inputted from the microcontroller block 110 is included in the address range where the data to which the error correcting code 132 is added is stored, based on the boundary address 331 held by the address storing unit 323, the address range being held by the address storing unit 323. Specifically, the region determining unit 324 compares the access request address 224 inputted from the microcontroller block 110 and the boundary address 331 held by the address storing unit 323, and judges whether or not the access request address 224 is included in the address range held by the address storing unit 323. The region determining unit outputs the result of determining as a region determination signal 325. The address converting unit 223, the selector 121, and the second selector 322 are controlled by the region determination signal 325 outputted from the region determining unit 324.

The second selector 322 sends the write data inputted from the microcontroller block into the error correcting code generating unit 321 or the memory 130, based on the region determination signal 325 outputted from the region determining unit 324. Specifically, in the case where it is determined by the region determining unit 324 that the access request address 224 is included in the address range where the data to which the error correcting code 132 is added is stored, the second selector 322 sends the write data inputted from the microcontroller block 110 to the error correcting code generating unit 321. In the case where it is determined by the region determining unit 324 that the access request address 224 is not included in the address range where the data to which the error correcting code 132 is added is stored, the second selector 322 sends, not via the error correcting code generating unit 321, the write data inputted from the microcontroller block 110 to the memory 130.

In the case where it is determined by the region determining unit 324 that the access request address 224 is included in the address range where the data to which the error correcting code 132 is added is stored, the address converting unit 223 converts the access request address 224 inputted from the microcontroller block 110 into the memory address 225 on the memory 130 which includes the region where the error correcting code 132 is stored, and sends it to the memory 130. In the case where it is determined by the region determining unit 324 that the access request address 224 is not included in the address range where the data to which the error correcting code 132 is added is stored, the address converting unit 223 sends the memory address 225 to the memory 130 without converting the access request address 224 inputted from the microcontroller block 110.

In the case where it is determined by the region determining unit 324 that the access request address 224 is included in the address range where the data to which the error correcting code 132 is added is stored, the selector 121 sends read data inputted from the memory 130 to the error correcting unit 222. In the case where it is determined by the region determining unit 324 that the access request address 224 is not included in the address range where the data to which the error correcting code 132 is added is stored, the selector 121 sends, not via the error correcting unit 222, the read data inputted from the memory 130 to the microcontroller block 110.

Next, an operation of the computer system 300 is described.

First, an operation of reading program data 131 from the memory 130 (an operation of reading data from the region with ECC) is described.

Initially, the microcontroller block 110 sends an instruction for reading the program data 131 to the memory control device 320. Furthermore, the microcontroller block 110 sends an address smaller than the boundary address 331 as the access request address 224 which is an address of the program data 131 to be read.

The region determining unit 324 compares the access request address 224 and the boundary address 331 held by the address storing unit 323. Here, since the access request address 224 is smaller than the boundary address 331, the region determining unit 324 outputs the region determination signal 325 having logic (for example, active) which indicates that the access request address 224 is smaller than the boundary address 331.

Since the region determination signal 325 is active, the memory address computing unit 226 converts the access request address 224 into the memory address 225 on the memory 130. The memory control device 320 reads the program data 131 of the converted memory address 225 and the error correcting code 132 corresponding to the program data 131. It should be noted that processing of the address conversion is the same as in the second embodiment and is not described in detail.

Since the region determination signal 325 is active, the selector 121 sends, to the error correcting unit 222, the read program data 131 and the read error correcting code 132. The error correcting unit 222 detects an error in the program data 131 and corrects the detected error in the program data 131, based on the read program data 131 and the read error correcting code 132. The error correcting unit 222 sends, to the microcontroller block 110, the error detected and error corrected program data 131.

Based on the above, the program data 131 is read from the memory 130. Furthermore, in the case where the error occurs, the program data 131 in which the error correcting unit 122 corrected the error is read.

Next, an operation of reading the data other than the program 133 from the memory 130 (an operation of reading data from the region without ECC) is described.

The microcontroller block 110 sends an instruction for reading the data other than the program 133 to the memory control device 320. In addition, the microcontroller block 110 sends an address larger than the boundary address 331 as the access request address 224 which is an address of the data other than the program 133 to be read.

The region determining unit 324 compares the access request address 224 and the boundary address 331 held by the address storing unit 323. Here, since the access request address 224 is larger than the boundary address 331, the region determining unit 324 outputs the region determination signal 325 having logic (for example, non-active) which indicates that the access request address 224 is larger than the boundary address 331.

Since the region determination signal 325 is non-active, the memory address computing unit 226 does not convert the access request address 224. The memory control device 320 reads the data other than the program 133, handling the access request address 224 as a memory address.

Since the region determination signal 325 is non-active, the selector 121 sends the read data other than the program 133 to the microcontroller block 110. Based on the above, the data other than the program 133 is read from the memory 130.

Next, an operation of writing the program data 131 into the memory 130 (an operation of writing data into the region with ECC) is described.

First, the microcontroller block 110 sends an instruction for writing the program data 131 to the memory control device 320. Furthermore, the microcontroller block 110 sends an address smaller than the boundary address 331 as the access request address 224 which is an address of the program data 131 to be written.

The region determining unit 324 compares the access request address 224 and the boundary address 331 held by the address storing unit 323. Here, since the access request address 224 is smaller than the boundary address 331, the region determining unit 324 outputs the region determination signal 325 having logic (for example, active) which indicates that the access request address 224 is smaller than the boundary address 331.

Since the region determination signal 325 is active, the memory address computing unit 226 converts the access request address 224 into the memory address 225 on the memory 130.

Since the region determination signal 325 is active, the second selector 322 sends, to the error correcting code generating unit 321, the program data 131 to be written inputted from the microcontroller block 110. The error correcting code generating unit 321 generates the error correcting code 132 from the program data 131 to be written.

The memory control device 320 writes, into the converted memory address 225, the program data 131 inputted from the microcontroller block 110 and the error correcting code 132 generated by the error correcting code generating unit 321. Based on the above, the program data 131 to which the error correcting code 132 is added is written into the memory 130.

Next, an operation of writing the data other than the program 133 into the memory 130 (an operation of writing data into the region without ECC) is described.

The microcontroller block 110 sends an instruction for writing the data other than the program 133 to the memory control device 320. Moreover, the microcontroller block 110 sends an address larger than the boundary address 331 as the access request address 224 which is an address of the data other than the program 133 to be written.

The region determining unit 324 compares the access request address 224 and the boundary address 331 held by the address storing unit 323. Here, since the access request address 224 is larger than the boundary address 331, the region determining unit 324 outputs the region determination signal 325 having logic (for example, non-active) which indicates that the access request address 224 is larger than the boundary address 331.

Since the region determination signal 325 is non-active, the memory address computing unit 226 does not convert the access request address 224. Since the region determination signal 325 is non-active, the second selector 322 sends, to the memory 130, the data other than the program 133 to be written inputted from the microcontroller block 110.

The memory control device 320 writes the data other than the program 133 inputted from the microcontroller block 110, handling the access request address 224 as the memory address 225. Based on the above, the data other than the program 133 to which the error correcting code 132 is not added is written into the memory 130.

As mentioned above, in the computer system 300 according to the third embodiment of the present invention, at a time of writing the data in the case where the access request address 224 is within the address range of the region with ECC, the address converting unit 223 performs the address conversion and the error correcting unit 222 detects the error and corrects the detected error. In addition, in the computer system 300, at a time of writing the data in the case where the access request address 224 is within the address range of the region with ECC, the address converting unit 223 performs the address conversion and the error correcting code generating unit 321 generates the error correcting code 132. Therefore, the error correcting code 132 is added to not only the program image described in the above first and second embodiments but also significant data having an impact on a system operation such as stack data of a program, and these data can be stored in the memory 130. Accordingly, the significant data having the impact on the system operation is protected with the error correcting code 132, so that robustness of the system can be enhanced. Furthermore, a region to which the error correcting code 132 is necessarily added can be confined to a predetermined address range in the memory 130, so that a required memory capacity can be reduced.

Moreover, the computer system 300 according to the third embodiment of the present invention includes the address storing unit 323 which holds the value for determining the address range of the region with ECC. Consequently, it is possible to freely set, for each system, an address range where data to which the error correcting code 132 is added is stored, the address range being in the memory 130, and this allows application to various devices.

It should be noted that although there is one fixed boundary address 331 and the access request address 224 is within the address range of the region with ECC in the case the access request address 224 is smaller than the boundary address 331 in the above description, the access request address 224 may be within the address range of the region with ECC in the case where the access request address 224 is larger than the boundary address 331. Additionally, there may be two boundary addresses 331, and an address range between the two boundary addresses may be used as the address range of the region with ECC. Further, there may be more than three boundary addresses, and the address range of the region with ECC may be designated more finely.

Moreover, although the address storing unit 323 holds the boundary address 331 as the fixed value in the above description, a user may arbitrarily set the boundary address held in the address storing unit 323. In other words, the address storing unit 323 may hold an externally inputted boundary address 331.

### Fourth Embodiment

When reading data by debug software, a memory control device according to a fourth embodiment of the present invention outputs an error correcting code and program data to the debug software. As a result, the debug software can detect an error and correct the detected error, based on the error correcting code and the program data, and perform debugging.

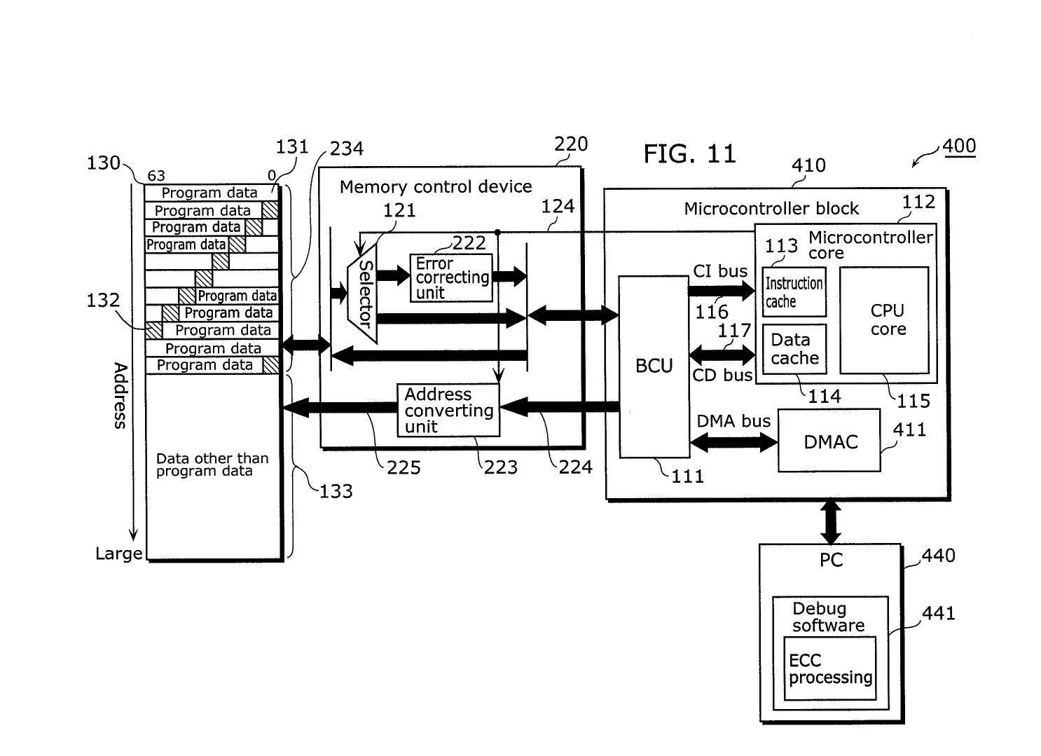

FIG. 11 is a diagram showing a configuration of a computer system including the memory control device according to the fourth embodiment of the present invention. A computer system 400 shown by FIG. 11 differs from the computer system 200 according to the second embodiment shown by FIG. 6 in a configuration of a microcontroller block 410 and in that it includes a Personal Computer (PC) 440. It should be noted that the same numeral references are given to the same components as in FIG. 6 and are not described in detail.

The microcontroller block 410 includes a bus control unit 111, a microcontroller core 112, a Direct Memory Access Controller (DMAC) 411.

The DMAC 411 reads, via the bus control unit 111, data held in a memory 130, similar to the microcontroller core 112. The DMAC 411 sends the read program data 131 and the read error correcting code 132 to the PC 440.

In the computer system 400, a memory control device 220 reads the data including the error correcting code 132 from the memory 130 with an instruction received from the microcontroller core 111 and the DMAC 411.

The PC 440 includes debug software 441. The debug software 441 is connected to, via a debug unit (not illustrated), the microcontroller block 410. The debug software 441 reads, via the DMAC 411, the data held in the memory 130, and debugs it. Furthermore, the debug software 441 detects the error in the read program data 131 and corrects the detected error in the read program data 131, based on the read program data 131 and the error correcting code 132.

When reading the data by the DMAC 411, a selector 121 sends, not via an error correcting unit 222, the program data 131 and the error correcting code 132 read from the memory 130 to the DMAC 411 of the microcontroller block 410.

Based on the above configuration, the debug software 441 can read, via the DMAC 411 and the memory control device 320, the data held in the memory 130 and the error correcting code 132. In addition, the debug software 441 detects the error in the read program data 131 and corrects the detected error in the read program data 131, based on the read program data 131 and the error correcting code 132.

As mentioned above, in the computer system 400 according to the fourth embodiment of the present invention, in the case where the debug software 441 in the PC 440 reads the data held in the memory 130, the debug software 441 detects the error in the program data 131 and corrects the detected error in the program data 131. Consequently, without adding hardware to the memory control device 220, the program data 131 of the memory 130 can be dumped correctly and debugged by the debug software 441.

### Fifth Embodiment

When reading data by debug software, a memory control device according to a fifth embodiment of the present invention detects an error and corrects the detected error, and outputs only program data to the debug software. As a result, it may not be necessary to detect the error and correct the detected error with the debug software.

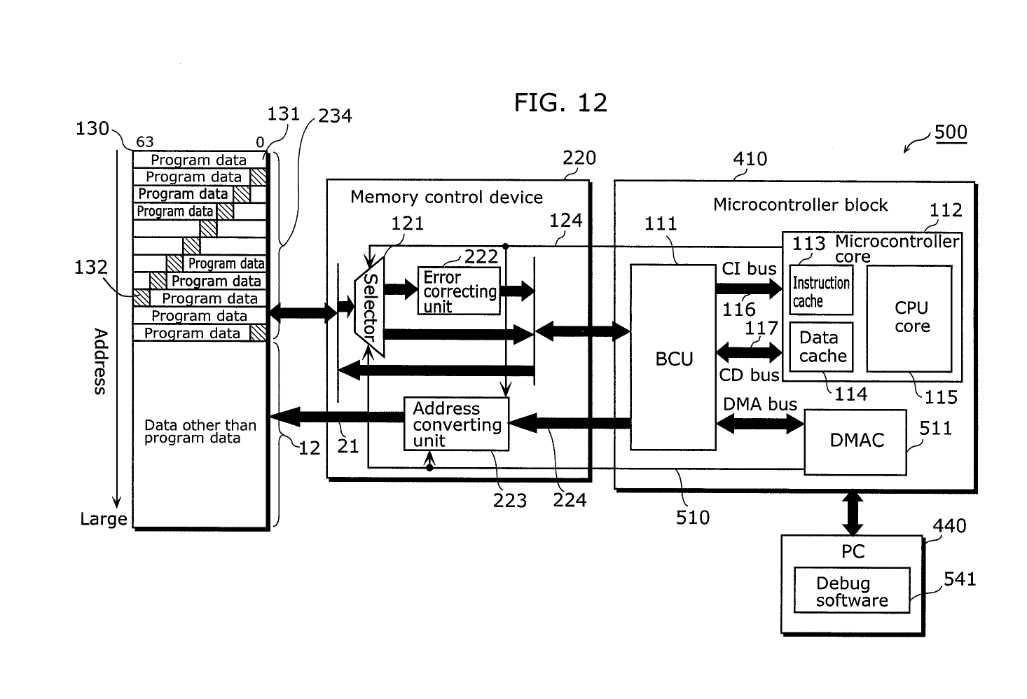

FIG. 12 is a diagram showing a configuration of a computer system including the memory control device according to the fifth embodiment of the present invention. A computer system 500 shown by FIG. 12 differs from the computer system 400 according to the fourth embodiment of FIG. 11 in respective configurations of debug software 541 included in a PC 440 and a DMAC 511 included in a microcontroller block 410 and in a method for controlling a selector 121 and an address converting unit 223 in a memory control device 220. It should be noted that the same numeral references are given to the same components as in FIG. 11 and are not described in detail.

The DMAC 511 reads, via a bus control unit 111, data held in a memory 130, similar to a microcontroller core 112. Furthermore, the DMAC 511 generates a DMAC reading signal 510 that becomes active when it reads the data held in the memory 130 and that becomes non-active except when it reads the data held in the memory 130.

In the computer system 500, the memory control device 220 reads data including an error correcting code 132 from the memory 130 with an instruction received from the microcontroller core 112 and the DMAC 511.

The debug software 541 is connected to, via a debug unit (not illustrated), the microcontroller block 410. The debug software 541 reads, via the DMAC 511, the data held in the memory 130, and debugs it.

In the case where at least one of the DMAC reading signal 510 from the DMAC 511 and an instruction reading signal 124 is active, the selector 121 sends the program data 131 and the error correcting code 132 read from the memory 130 to an error correcting unit 222. In the case where both the DMAC reading signal 510 from the DMAC 511 and the instruction reading signal 124 are non-active, the selector 121 sends, not via the error correcting unit 222, the data read from the memory 130 to the microcontroller block 410.

In the case where at least one of the DMAC reading signal 510 and the instruction reading signal 124 is active, the address converting unit 223 converts an access request address 224 from the microcontroller block 410 into an memory address 225 on the memory 130 and outputs it to the memory 130. In the case where both the DMAC reading signal 510 and the instruction reading signal 124 are non-active, the address converting unit 223 does not convert the access request address 224 from the microcontroller block 410 and outputs it as the memory address 225 to the memory 130.

Based on the above configuration, in the case where the data held in the memory 130 is read with the debug software 541 in the PC 440, the DMAC 511 has the DMAC reading signal 510 active. Accordingly, the address converting unit 223 converts the access request address 224 into the memory address 225 on the memory 130. The memory control device 220 reads the program data 131 and the error correcting code 132 of the converted memory address 225. The selector 121 sends the read program data 131 and the read error correcting code 132 to the error correcting unit 222. The error correcting unit 222 detects the error in the read program data 131 and corrects the detected error in the read program data 131, based on the read program data 131 and the read error correcting code 132. The error correcting unit 222 sends, to the microcontroller block 410, the error detected and error corrected program data 131. The DMAC 511 obtains, from the error correcting unit 222, via the bus control unit 111, the error detected and error corrected program data 131, and outputs it to the debug software 541. Based on the above, the error detected and error corrected program data 131 is sent to the debug software 541.

In the above-described the computer system 200 according to the second embodiment, whether the data read from the memory 130 is sent to the error correcting unit 222 or directly to the microcontroller block 110 is selected only with control by the instruction reading signal 124. Therefore, when the data held in the memory 130 is read by the debug software 541, the program data 131 and the error correcting code 132 are read. For a user who wants to debug a program, the error correcting code 132 is unnecessary data. On the other hand, in the computer system 500 according to the fifth embodiment, the selector 121 and the address converting unit 223 are controlled by the instruction reading signal 124 and the DMAC reading signal 510. Therefore, when the data held in the memory 130 is read by the debug software 541, the error detected and error corrected program data 131 is read.

As mentioned above, in the computer system 500 according to the fifth embodiment of the present invention, although contents of the memory 130 is read by the debug software 541, only the program data can be read, similar to a normal memory (a memory without ECC). Moreover, since the memory control device 220 detects the error and correct the detected error, it is not necessary to perform a processing of detecting the error and correcting the detected error in the debug software 541.

### Sixth Embodiment

In the case where an error in program data held in a memory is detected, a memory control device according to a sixth embodiment of the present invention changes, by controlling a bus control unit, the memory to which the program data is referenced. As a result, in the case where the error occurs, a microcontroller block can read the program data from other memory.

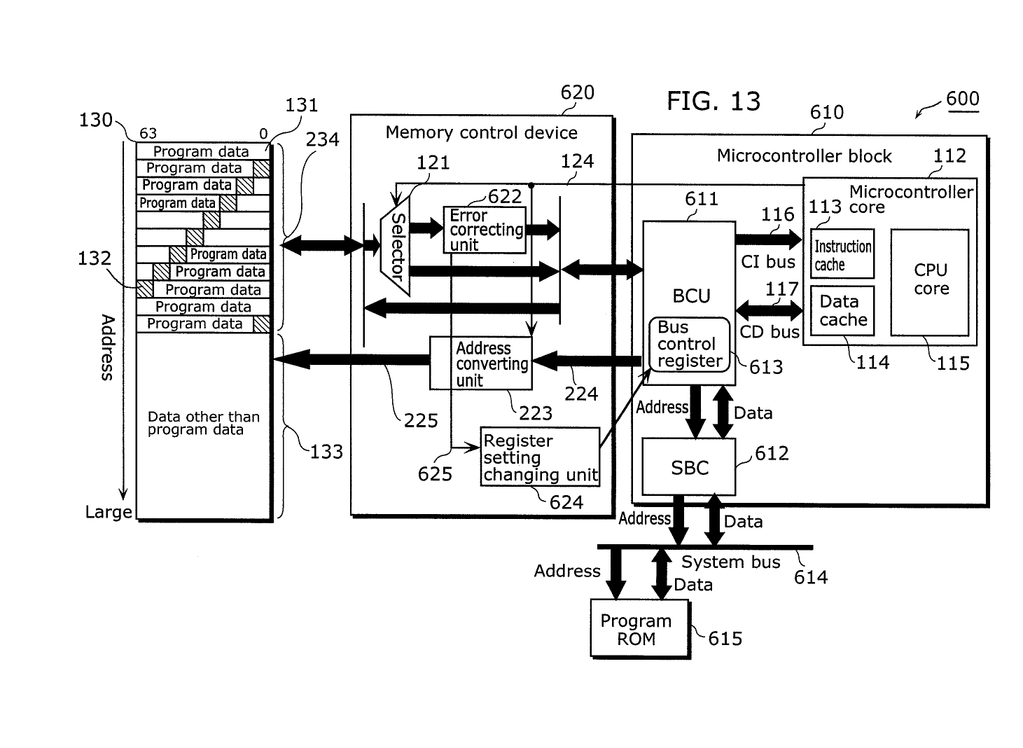

FIG. 13 is a diagram showing a configuration of a computer system including the memory control device according to the sixth embodiment of the present invention. A computer system 600 shown by FIG. 13 differs from the computer system 200 according to the second embodiment shown by FIG. 6 in respective configurations of a memory control device 620 and a microcontroller block 610 and in that it includes a system bus 614 and a program ROM 615. It should be noted that the same numeral references are given to the same components as in FIG. 6 and are not described in detail.

The microcontroller block 610 includes a bus control unit 611, a microcontroller core 112, a System Bus Controller (SBC) 612.

The SBC 612 controls the system bus 614. The program ROM 615 is arranged on the system bus 614.

The bus control unit 611 assigns, into the memory control device 620 or the SBC 612, an access request sent from the microcontroller core via a CI bus 116 and a CD bus 117. Specifically, the bus control unit 611 assigns the access request into the memory control device 620 or the SBC 612, based on an address value of the access request from the CI bus 116 and the CD bus 117. The bus control unit 611 includes a bus control register 613. The bus control register 613 holds information for determining a destination of the access request for the bus control unit 611.

The memory control device 620 includes a selector 121, an error correcting unit 622, an address converting unit 223, and a register setting changing unit 624.

The error correcting unit 622 detects an error in program data 131 read from the memory 130 and corrects the detected error in the read program data 131, based on the program data 131 and the error correcting code 132 read from the memory 130. Further, when detecting the error in the data, the error correcting unit 622 has an error detecting signal 625 active.

In the case where the error detecting signal 625 is active (in the case where the error correcting unit 625 detects the error), the register setting changing unit 624 changes the information held in the bus control register 613. Specifically, the register setting changing unit 624 changes an address of the memory 130 to be held in the bus control register 613 into an address of the SBC 612. Consequently, the bus control unit 611 sends, to the SBC 612, the access request from the CI bus 116 and the CD bus 117, the access request being originally sent to the memory 130.

As mentioned above, in the case where the error correcting unit 622 detects the error in the program data 131 in the memory 130, in the computer system 600 according to the sixth embodiment of the present invention, setting of the bus control register 613 is changed. As a result, access to the memory 130 is handed to the SBC 612. Therefore, arranging the program ROM 615 on the system bus 614 and using data of the program ROM 615 without using the memory in which the error occurred allows continuation of the system operation. Accordingly, it is possible to enhance robustness of the computer system 600.

### Seventh Embodiment

In the case where an error in program data held in a memory is detected, a memory control device according to a seventh embodiment of the present invention changes, by controlling a CPU core, the memory to which the program data is referenced. As a result, in the case where the error occurs, a microcontroller block can read the program data from other memory.

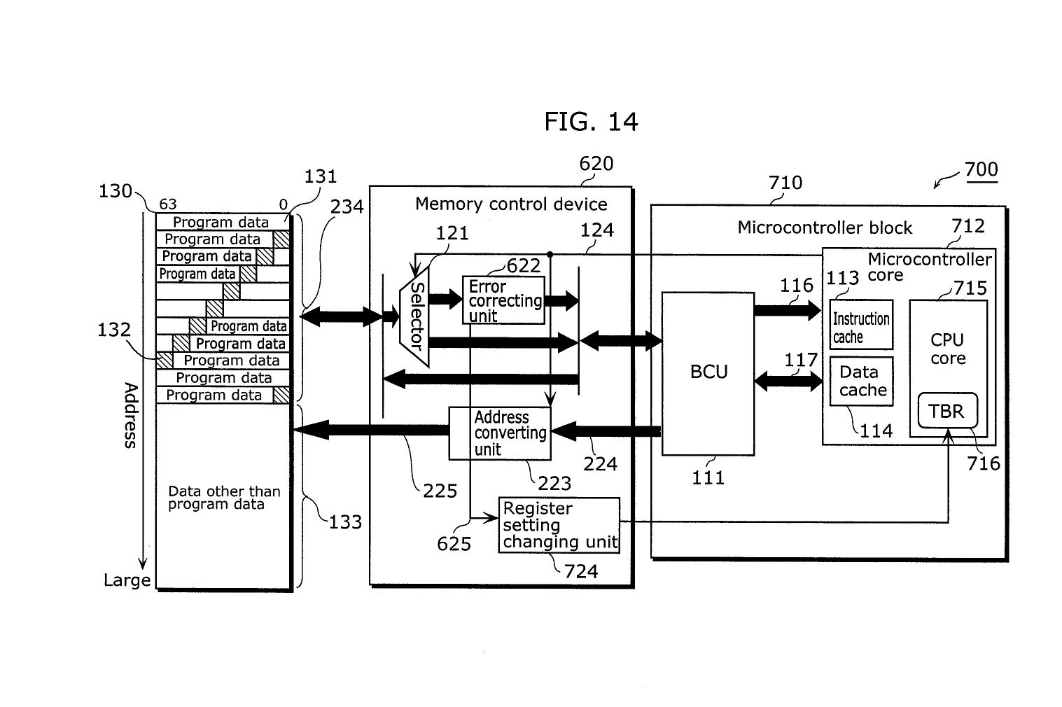

FIG. 14 is a diagram showing a configuration of a computer system including the memory control device according to the seventh embodiment of the present invention. A computer system 700 shown by FIG. 14 differs from the computer system 600 according to the sixth embodiment shown by FIG. 13 in respective configurations of a CPU core 715 in a microcontroller block 710 and a register setting changing unit 724 in a memory control device 620. It should be noted that the same numeral references are given to the same components as in FIG. 13 and are not described in detail.

The microcontroller block 710 includes a bus control unit 111 and a microcontroller core 712. The microcontroller core 712 includes an instruction cache 113, a data cache 114, and the CPU core 715. The CPU core 715 includes a Trap Base Register (TBR) 716.

The TBR 716 is a register which holds information indicating an arranged position of a program. Specifically, the TBR 716 holds the information which indicates an arranged position of an interrupt vector indicating an address of an interrupt handler. Here, the interrupt handler is a special program which interrupts a process currently in execution and branches to execute an interrupt process when an interrupt occurs in processing the CPU core 715. Since the interrupt vector is arranged in the memory 130 in a normal time, information indicating an address in the memory 130 during system start-up is set to the TBR 716.

In the case where an error detecting signal 625 is active (in the case where an error correcting unit 622 detects the error), the register setting changing unit 724 changes the information held in the TBR 716. Specifically, in the case where the error detecting signal 625 is active, the register setting changing unit 724 changes setting of the TBR 716 to an address of a program ROM and the like on a system bus.

As mentioned above, in the computer system 700 according to the seventh embodiment of the present invention, the error correcting unit 622 detects the error, and a value of the TBR 716 is changed in the case where an error detection interrupt occurs. Consequently, the microcontroller block 710 can perform the interrupt process without using the memory 130 in which the error occurred. Accordingly, it is possible to enhance robustness of the computer system 700.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention can be applied to a memory control device, and particularly to a data reproducing and recording device such as a DVD recorder in which an error in data read from a memory is corrected.

What is claimed is:

1. A memory control device which reads data including an error correcting code from a memory, said device comprising:
an error correcting unit operable to detect an error in the data and correct the detected error in the data, based on the error correcting code, and to send the error detected and error corrected data to the outside; and
a selector which selects whether to send the data read from the memory to said error correcting unit or to the outside.

2. The memory control device according to claim 1,
wherein said memory control device reads the data including the error correcting code from the memory with an instruction received from a microcontroller block including a CPU, and
said memory control device further comprises an instruction replacing unit operable to replace the error correcting code with an instruction unrelated to an operation of the CPU and to send the instruction to the outside.

3. The memory control device according to claim 1, further comprising
an address converting unit operable to convert an address inputted from the outside into an address on the memory including a region where the error correcting code is stored.

4. The memory control device according to claim 3,
wherein said memory control device reads the data including the error correcting code with an instruction received from a microcontroller block including a CPU,
said selector sends the data read from the memory to said error correcting unit, in a case where an instruction reading signal which becomes a first logic when reading program data by the microcontroller block is the first logic, and sends the data read from the memory to the microcontroller block, in a case where the instruction reading signal is not the first logic, and
said address converting unit is operable to convert an address inputted from the microcontroller block into the address on the memory including the region where the error correcting code is stored, in the case where the instruction reading signal is the first logic.

5. The memory control device according to claim 3, further comprising:
an error correcting code generating unit operable to generate the error correcting code to data inputted from the outside;
an address determining unit operable to determine whether or not the address inputted from the outside is included in a predetermined address range; and
a second selector which sends the data inputted from the outside to said error correcting code generating unit, in a case where it is determined by said address determining unit that the address inputted from the outside is included in the predetermined address range, and sends the data to the memory, in a case where it is determined by said address determining unit that the address inputted from the outside is not included in the predetermined address range,
wherein said selector sends the data read from the memory to said error correcting unit, in the case where it is determined by said address determining unit that the address inputted from the outside is included in the predetermined address range, and sends the data read from the memory to the outside, in the case where it is determined by said address determining unit that the address inputted from the outside is not included in the predetermined address range, and
said address converting unit is operable to convert the address inputted from the outside into the address on the memory including the region where the error correcting code is stored, in a case where it is determined by said address determining unit that the address inputted from the outside is included in the predetermined address range.

6. The memory control device according to claim 5, further comprising
an address storing unit operable to hold, as a fixed value, a value for determining the predetermined address range,
wherein said address determining unit is operable to determine whether or not the address inputted from the outside is included in the predetermined address range, based on the value for determining the predetermined address range held in said address storing unit.

7. The memory control device according to claim 5, further comprising
an address storing unit operable to hold a value for determining the predetermined address range inputted from the outside,
wherein said address determining unit is operable to determine whether or not the address inputted from the outside is included in the predetermined address range, based on the value for determining the predetermined address range held in said address storing unit.

8. The memory control device according to claim 1,
wherein said memory control device reads the data including the error correcting code from the memory with an instruction received from a Direct Memory Access Controller (DMAC), and
said selector sends the data and the error correcting code read from the memory to the DMAC, in a case where an instruction for reading is from the DMAC.

9. The memory control device according to claim 1,
wherein said memory control device reads the data including the error correcting code from the memory with an instruction received from a microcontroller block including a CPU and a DMAC, and
said selector sends the data read from the memory to said error correcting unit, in a case where an instruction reading signal which becomes a first logic when reading program data by the microcontroller block is the first logic or in a case where a DMAC reading signal which becomes a second logic when reading data by the DMAC, and sends the data read from the memory to the microcontroller block or the DMAC, in a case where the instruction reading signal is not the first logic and the DMAC reading signal is not the second logic.

10. The memory control device according to claim 1,
wherein said memory control device reads the data including the error correcting code from the memory with an instruction received from a microcontroller block including a CPU,
the microcontroller block includes:
a bus control unit operable to assign an instruction from the CPU into either said memory control device or another device; and
a register which holds information for determining a destination of the instruction for the bus control unit, and
said memory control device further includes a register setting changing unit operable to change the information held in the register, in a case where said error correcting unit detects the error.

11. The memory control device according to claim 1,
wherein an instruction from a microcontroller block including a CPU instructs said memory control device to read the data including the error correcting code,
the CPU includes a register which holds information indicating an arranged position of a program, and
said memory control device further comprises a register setting changing unit operable to change the information held in the register, in a case where said error correcting unit detects the error.

12. A computer system comprising:
a memory control device which reads data including an error correcting code from a memory;
a data region inserting unit operable to insert a data region having a predetermined size into an object which is a compiled program source;
an address resolution unit operable to perform address resolution on an operand of the object including the data region inserted by said data region inserting unit;
an error correcting code computing unit operable to compute an error correcting code of the object; and
an error correcting code writing unit operable to write the error correcting code computed by said error correcting code computing unit into the data region,
wherein said memory control device writes, into the memory, the object including the data region into which the error correcting code is written by said error correcting code writing unit, and
said memory control device includes:
an error correcting unit operable to detect an error in the data and correct the detected error in the data, based on the error correcting code, and to send the error detected and error corrected data to the outside; and
a selector which selects whether to send the data read from the memory to said error correcting unit or to the outside.

13. A computer system comprising:
a memory;
a memory control device which writes and reads data including an error correcting code into and from the memory; and
a microcontroller block which sends, to said memory control device, an instruction for writing and reading the data into and from the memory,
wherein said memory control device includes:
an error correcting unit operable to detect an error in the data and correct the detected error in the data, based on the error correcting code, and to send the error detected and error corrected data to the outside; and
a selector which selects whether to send the data read from the memory to said error correcting unit or to the outside.

14. A data reproducing and recording device comprising:
a memory control device which reads data including an error correcting code from a memory;
a data region inserting unit operable to insert a data region having a predetermined size into an object which is a compiled program source;
an address resolution unit operable to perform address resolution on an operand of the object including the data region inserted by said data region inserting unit;
an error correcting code computing unit operable to compute an error correcting code of the object; and
an error correcting code writing unit operable to write the error correcting code computed by said error correcting code computing unit into the data region,
wherein said memory control device writes, into the memory, the object including the data region into which the error correcting code is written by said error correcting code writing unit, and
said memory control device includes:
an error correcting unit operable to detect an error in the data and correct the detected error in the data, based on the error correcting code, and to send the error detected and error corrected data to the outside; and
a selector which selects whether to send the data read from the memory to said error correcting unit or to the outside.

15. A method for generating program data to be written into a memory by a memory control device,
wherein said memory control device reads data including an error correcting code from a memory and includes:
an error correcting unit operable to detect an error in the data and correct the detected error in the data, based on the error correcting code, and to send the error detected and error corrected data to the outside; and
a selector which selects whether to send the data read from the memory to said error correcting unit or to the outside, and
said method for generating the program data comprises the steps of:
inserting a data region having a predetermined size into an object which is a compiled program source;
performing address resolution on an operand of the object including the data region inserted in said inserting;
computing an error correcting code of the object; and
writing the error correcting code computed in said computing into the data region.
